(19) United States
(12) Patent Application Publication
(10) Pub. No.: US 2018/0260389 A1
(43) Pub. Date: Sep. 13, 2018

(54) ELECTRONIC DOCUMENT SEGMENTATION AND RELATION DISCOVERY BETWEEN ELEMENTS FOR NATURAL LANGUAGE PROCESSING

(71) Applicant: FUJITSU LIMITED, Kawasaki-shi (JP)

(72) Inventors: Mehdi BAHRAMI, Santa Clara, CA (US); Wei-Peng CHEN, Fremont, CA (US); Takuki KAMIYA, San Jose, CA (US)

(73) Assignee: FUJITSU LIMITED, Kawasaki-shi (JP)

(21) Appl. No.: 15/453,893

(22) Filed: Mar. 8, 2017

(51) Int. Cl. G06F 17/28; G06F 17/27; G06F 17/21

(52) U.S. Cl. CPC G06F 17/2818; G06F 17/272; G06F 17/2785; G06F 17/2775; G06F 17/218

(57) ABSTRACT

A method may include identifying an electronic document that includes one or more elements. The method may further include generating a relationship model to provide a probability of assigning relationship between the elements of the electronic document. The method may also include identifying metadata associated with the electronic document. The method may include modifying the relationship model based on the identified metadata. The method may further include segmenting the electronic document into at least two segments based on the modified relationship model. The method may also include extracting information by using natural language processing on the electronic document in view of the at least two segments.

### FIELD

The embodiments discussed herein are related to an electronic document segmentation and relation discovery between elements for a natural language processing system and related methods.

### BACKGROUND

Electronic documents may include text written in natural language that may be easily understood by humans. Natural-language processing (NLP) may be used to generate a semantic representation of the text by analyzing the words of the text.

The subject matter claimed herein is not limited to embodiments that solve any disadvantages or that operate only in environments such as those described. Rather, this background is only provided to illustrate one example technology area where some embodiments described herein may be practiced.

### SUMMARY

According to an aspect of an embodiment, a method may include identifying an electronic document that includes one or more elements. The method may further include generating a relationship model between the elements of the electronic document. The method may also include identifying metadata associated with the electronic document. The method may include modifying the relationship model based on the identified metadata. The method may further include segmenting the electronic document into at least two segments based on the modified relationship model. The method may also include extracting information from the electronic document in view of the at least two segments.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates a block diagram of an example operating environment of a NLP system;

FIG. 2 illustrates a flow diagram of an example method related to a NLP system;

FIG. 3 illustrates a flow diagram of an example method to generate a relationship model;

FIG. 4 illustrates a flow diagram of an example method related to tagging an electronic document;

FIG. 5 illustrates a flow diagram of an example method of segmentation of an electronic document;

FIG. 6 illustrates a flow diagram of an example method of natural language processing of any type of electronic document;

FIG. 7A illustrates an example electronic document that may be processed to generate an initial relationship model;

FIG. 7B illustrates an example electronic document that may be processed to generate an updated relationship model;

FIG. 8 illustrates example segmentation of an electronic document;

FIG. 9 illustrates an example text extraction using document segmentation information; and

FIG. 10 illustrates a diagrammatic representation of a machine in the example form of a computing device within which a set of instructions, for causing the machine to perform any one or more of the methods discussed herein, may be executed, all arranged in accordance with at least one embodiment described herein.

### DESCRIPTION OF EMBODIMENTS

An electronic document may include unstructured text, data and objects, such as human language texts, images, videos, and tables. Conventionally, to process content and text inside an electronic document (e.g., a webpage), a computer-based system may extract the text and then process the text through Natural Language Processing (NLP) methods. However, extracting information from the web and processing data may not provide accurate information in some domains. For instance, some programming language documentation and Application Programming Interface (API) documentation may describe the related code in short sentences or even in incomplete sentences. Extracting information and processing from short or incomplete sentences may not be useful.

Aspects of the present disclosure address these and other shortcomings of conventional computer-based NLP systems by providing electronic document segmentation and relation discovery between elements for the NLP systems and final processing of the content by using NLP algorithms. These and other features may provide better understanding of the content. In an example where the electronic document includes a webpage, the improved NLP system may implement a method that uses the standard web markup language, HyperText Markup Language (HTML) tags and Cascading Style Sheets (CS S) styles for web pages by using machine-learning methods. The improved NLP system may discover relationships between elements (e.g., HTML tags) of the webpage. The improved NLP system may also find relationships between different sections of a content based on: i) different format types, such as a PDF file, Word Document, RDF, ODF, XPS, XML, Power Point file, Excel File, PS file; ii) processing the content, such as finding semantic relationships between discovered elements and their relationships.

In an example, the improved NLP system may generate a relationship model of HTML tags in the webpage. The relationship model may include a hierarchy model of the HTML tags. The improved NLP system may adjust the HTML tags and/or the relationship model based on the HTML tags (“alpha” parameter) appearing in the document. The improved NLP system may adjust the HTML tags and/or the relationship model based on CSS styles (“beta” parameter). The improved NLP system may use a training set of data (e.g., a training model) to provide a probability of assigning relationship between elements. The training set model may allow the improved NLP system to adjust the relationship assignment in the relationship model between elements for any elements, even unseen or non-visible elements. The improved NLP system may implement machine-learning techniques from this adjusted relationship model to identify different behaviors. The improved NLP system may use NLP to extract information (“gamma” parameter) from the webpage. In this manner, the improved NLP system may use the adjusted relationship model to find related extracted information (meaningful information) in the above-described process that uses the alpha, beta, and gamma parameters.

For webpages, HTML and CSS may provide information in addition to information that may be gleaned from the visible content on the webpage. For instance, a text with bold format, larger font or different CSS-based color may show the title of the next sentence/paragraph. In another example, a first HTML tag inside the second HTML tag may show a correlation between two texts or a correlation between other objects in a webpage or multiple webpages, such as images to images, text to images, title to sentence(s), sentence(s) to other sentence(s).

The improved NLP system may use statistical model to generate a relationship model with a set of metadata that may include HTML tags and CSS styles for a webpage or the format for other types, such as a PDF file. The improved NLP system may use the metadata to identify relationships between elements of a webpage including texts, tables, images and videos. In an example, the improved NLP system may use a training set of data to generate the relationship model that includes relationships between elements. The relationship model can be generated by using a training set that allows the model to be applied to unseen elements.

The relationship model may provide a probability relation between elements of the electronic document(s). The improved NLP system may use the probability relation and based on discovered relation elements to provide a segmentation of the electronic document. Each segment may include different elements, such as texts, images, videos, tables. The improved NLP system may label each segment based on HTML hierarchy tags and CSS styles behind the visible elements on the web that the improved NLP system to have more metadata on the objects. For instance, a label, an incomplete sentence and a table can be labeled as one segment that allows the improved NLP system to process the table based on its title and incomplete sentence.

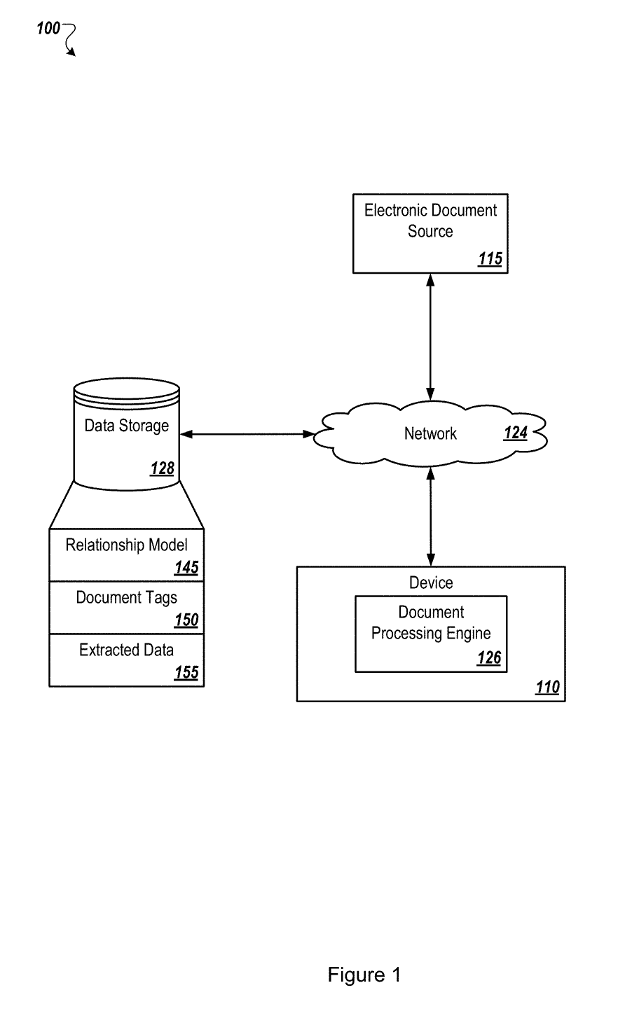

FIG. 1 illustrates a block diagram of an example operating environment 100 of a NLP system, arranged in accordance with at least one embodiment described herein. As depicted in FIG. 1, the operating environment 100 may include a computer device 110, one or more electronic document sources 115, a network 124 and a data storage 128.

The computer device 110 may include a computer-based hardware device that includes a processor, memory, and communication capabilities. The computer device 110 may be coupled to the network 124 to communicate data with any of the other components of the operating environment 100. Some examples of the computer device 110 may include a mobile phone, a smartphone, a tablet computer, a laptop computer, a desktop computer, a hardware server, or another processor-based computing device configured to function as a server, etc.

The one or more electronic document sources 115 may include any computer-based source for electronic documentation. For example, an electronic document source 115 may include a server, client computer, repository, etc. The one or more electronic document sources 115 may store electronic documents in any electronic format. The electronic document may include any type of electronic document, such as a webpage, word-processing document, spreadsheet, portable document format (PDF), XML document, etc. Further the electronic documents may be machine-readable and/or human readable. The electronic documents may be in any language. For example, the electronic documents may be in any human language (e.g., English, Japanese, German).

An electronic document may include any number of page elements. Example page elements may include visible text, tables, content, images, video, and audio, etc. The electronic document may also include or be associated with non-visible objects, such as HTML tags, CSS styles, etc. The HTML tags and CSS styles are typically not visible to viewers without viewing the page source.

The network 124 may include any communication network configured for communication of signals between any of the components (e.g., 110, 115, and 128) of the operating environment 100. The network 124 may be wired or wireless. The network 124 may have numerous topologies including a star topology, a token ring topology, or another suitable configuration. Further, the network 124 may include a local area network (LAN), a wide area network (WAN) (e.g., the Internet), and/or other interconnected data paths across which multiple devices may communicate. In some embodiments, the network 124 may include a peer-to-peer network. The network 124 may also be coupled to or include portions of a telecommunications network that may enable communication of data in a variety of different communication protocols.

In some embodiments, the network 124 includes or is configured to include a BLUETOOTH® communication network, a Z-Wave® communication network, an Insteon® communication network, an EnOcean® communication network, a wireless fidelity (Wi-Fi) communication network, a ZigBee communication network, a HomePlug communication network, a Power-line Communication (PLC) communication network, a message queue telemetry transport (MQTT) communication network, a MQTT-sensor (MQTT-S) communication network, a constrained application protocol (CoAP) communication network, a representative state transfer application protocol interface (REST API) communication network, an extensible messaging and presence protocol (XIVIPP) communication network, a cellular communications network, any similar communication networks, or any combination thereof for sending and receiving data. The data communicated in the network 124 may include data communicated via short messaging service (SMS), multimedia messaging service (MMS), hypertext transfer protocol (HTTP), direct data connection, wireless application protocol (WAP), e-mail, smart energy profile (SEP), ECHONET Lite, OpenADR, or any other protocol.

The data storage 128 may include any memory or data storage. The data storage 128 may include network communication capabilities such that other components in the operating environment 100 may communicate with the data storage 128. In some embodiments, the data storage 128 may include computer-readable storage media for carrying or having computer-executable instructions or data structures stored thereon. The computer-readable storage media may include any available media that may be accessed by a general-purpose or special-purpose computer, such as a processor. For example, the data storage 128 may include computer-readable storage media that may be tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may be included in the data storage 128.

The data storage 128 may store various data. The data may be stored in any data structure, such as a relational database structure. For example, the data storage 128 may include at least one relationship model 145 (which may include an initial relationship model and an updated relationship model), a document tags 150, extracted data 155, etc.

The computer device 110 may include a document processing engine 126. In some embodiments, the document processing engine 126 may include a stand-alone application (“app”) that may be downloadable either directly from a host or from an application store from the Internet. The document processing engine 126 may perform various operations relating to the NLP system and to the generation and modification of a relationship model of an electronic document, segmentation of the electronic document, and data extraction from the electronic document, as described in this disclosure. The document processing engine 126 may use visible text as well as hidden metadata (e.g., HTML, CSS) to process and extract information from the electronic document.

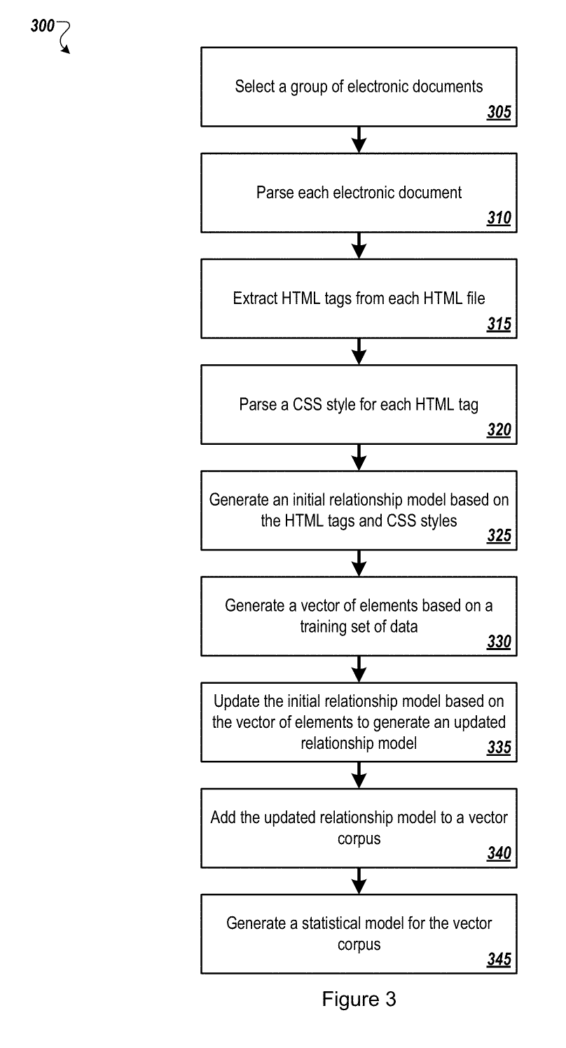

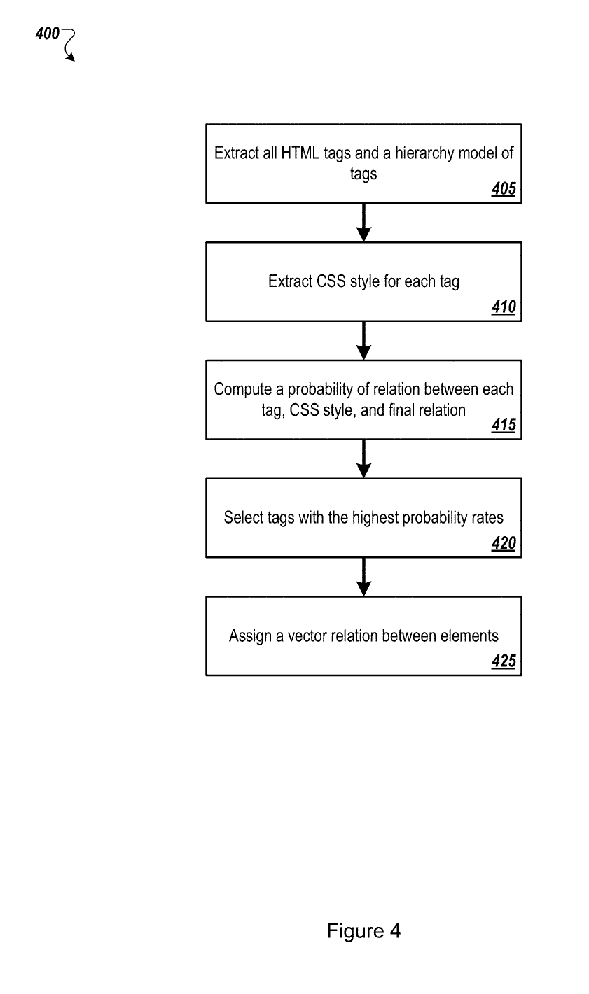

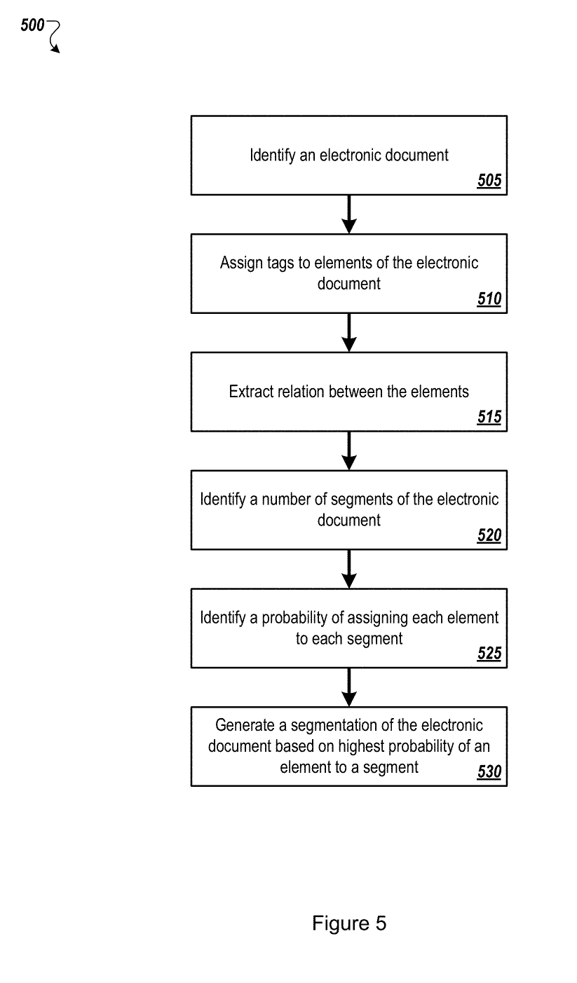

In operation, the document processing engine 126 may obtain electronic documents from one or more electronic document sources 115 and may extract features (e.g., elements) from the electronic documents. The document processing engine 126 may generate a relationship model of elements in the electronic document and adjust the relationship model, as further described in conjunction with FIG. 3. The document processing engine 126 may tag the electronic document based on the relationships between elements, as further described in conjunction with FIG. 4. The document processing engine 126 may segment the electronic document based on relationships between elements and/or tags of the elements, as further described in conjunction with FIG. 5.

Modifications, additions, or omissions may be made to the operating environment 100 without departing from the scope of the present disclosure. For example, the operating environment 100 may include any number of the described devices and services. Moreover, the separation of various components and servers in the embodiments described herein is not meant to indicate that the separation occurs in all embodiments. Moreover, it may be understood with the benefit of this disclosure that the described components and servers may generally be integrated together in a single component or server or separated into multiple components or servers.

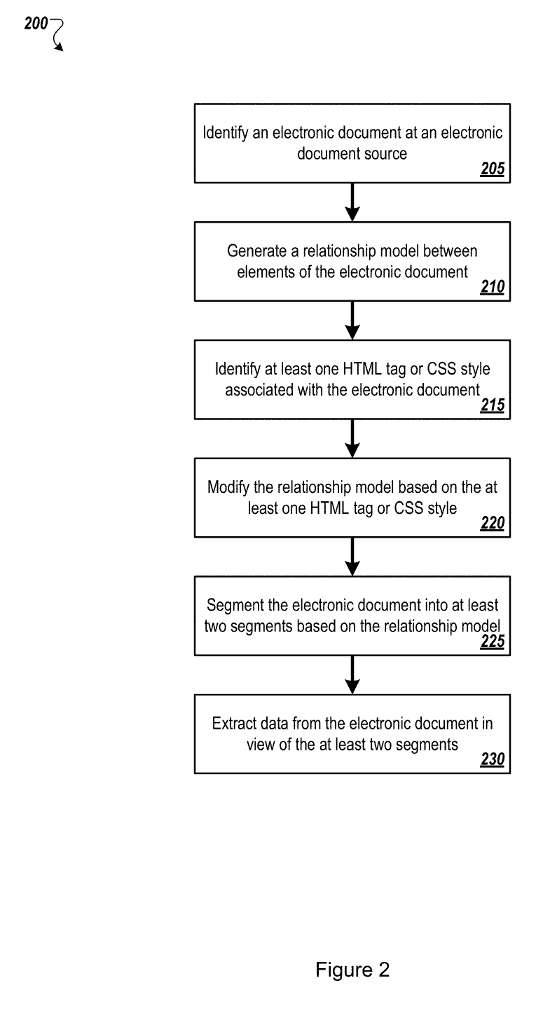

FIGS. 2-6 illustrate flow diagrams of example methods related to a NLP system. The methods may be performed by processing logic that may include hardware (circuitry, dedicated logic, etc.), software (such as is run on a general purpose computer system or a dedicated machine), or a combination of both, which processing logic may be included in the document processing engine 126 of FIG. 1, or another computer system or device. However, another system, or combination of systems, may be used to perform the methods. For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 2 illustrates a flow diagram of an example method 200 related to a NLP system. The method 200 may begin at block 205, where the processing logic may identify an electronic document at an electronic document source. In at least one embodiment, the processing logic may crawl one or more electronic document sources for electronic documents. For example, the processing logic may crawl the one or more electronic document sources 115 of FIG. 1 for electronic documents. The processing logic may crawl the one or more sources in response to a request to identify API documentation. For example, a software developer or end user may electronically submit a request to use an API or particular functionality using an API. The processing logic may collect any number of electronic documents from the one or more electronic document sources.

At block 210, the processing logic may generate a relationship model between elements of the electronic document. The processing logic may generate the relationship model based on a training set of data. The training set of data may include predefined relationships of elements. For example, a training set of data may include some samples of relation between HTML tags and/or HTML tag hierarchy, CSS styles, and a set of words for a specific domain. The training set of data may be used to teach the processing logic and/or an algorithm to provide different behavior based on the training set of data. The training set of data may include a structure of HTML tags, nested HTML tags, CSS styles, domain terminologies, etc. The processing logic may use the training set of data to generate a parse tree of the HTML tags, which may be referred to as an initial parse tree. The initial parse tree may include a statistical model of a corpus of electronic documents for appearing elements based on their metadata (e.g., HTML tags, CSS styles and ontologies of a domain). The HTML tags may be referred to as an α parameter and the CSS styles may be referred to as a β parameter. The initial parse tree may include a hierarchy model of HTML tags. In at least one embodiment, the processing logic may generate the relationship model between elements of the electronic document and adjust the relationship model, as further described in conjunction with FIG. 3.

At block 215, the processing logic may identify at least one HTML tag or CSS style associated with the electronic document. The processing logic may use the training set of data to estimate a probability of relation between elements in the relationship model generated at block 215 based on their HTML tags, CSS styles and the probability of the assignment. For example, the processing logic may tag the electronic document with a set of vectors that shows relation between elements. The processing logic may assign at least one relation vector between elements. The processing logic may add the assigned relation vector as an individual file for the source electronic document. In at least one embodiment, the processing logic may add the assigned relation vector as a set of HTML tags to the source electronic document.

At block 220, the processing logic may modify the relationship model based on the at least one HTML tag or CSS style. For example, the processing logic may adjust the initial relationship model by using both HTML tags and CSS style to generate a modified relationship model.

At block 225, the processing logic may segment the electronic document into at least two segments based on the relationship model. The processing logic may use one or more relation vectors (such as a relation vector assigned at block 215) to provide a segmentation view (semantic view) of the electronic document.

At block 230, the processing logic may extract information from the electronic document in view of the at least two segments. In at least one embodiment, the processing logic may apply text extraction, which may be defined as a γ parameter and it is generated based on Natural Language Processing on the electronic document by using page segmentation. In at least one embodiment, when extracting information from the electronic document, the processing logic may identify segmentation of each extracted data. The processing logic may organize the extracted data based on page segmentation to find related extracted data.

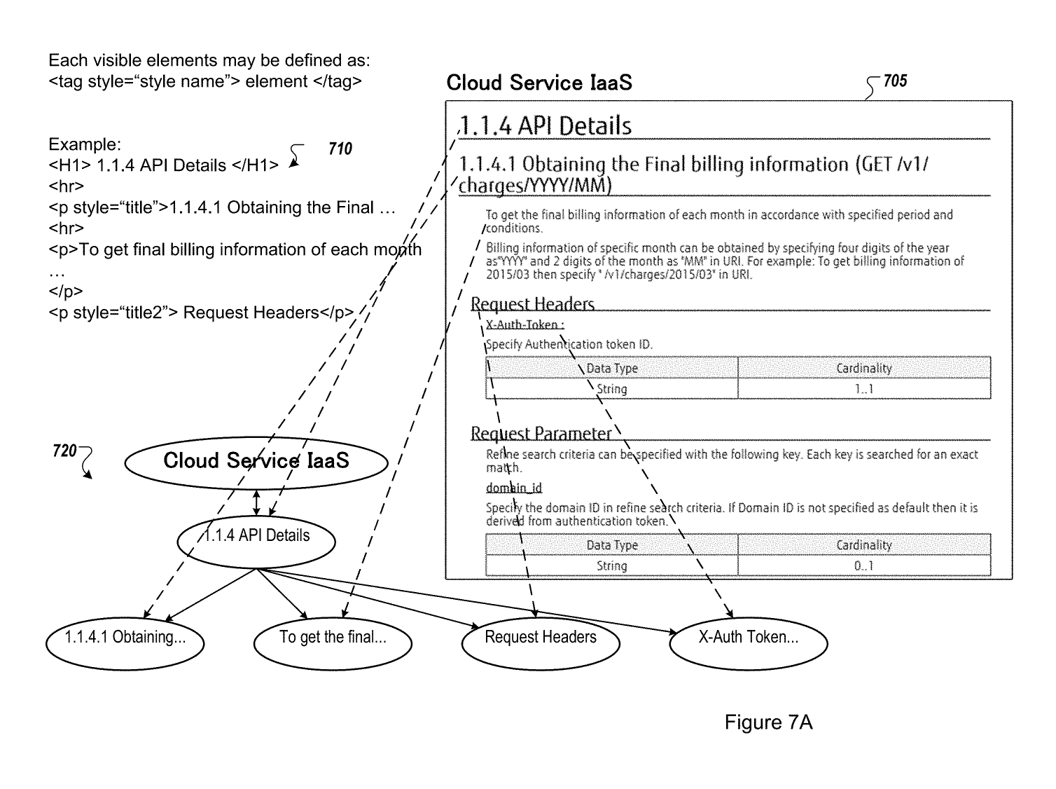

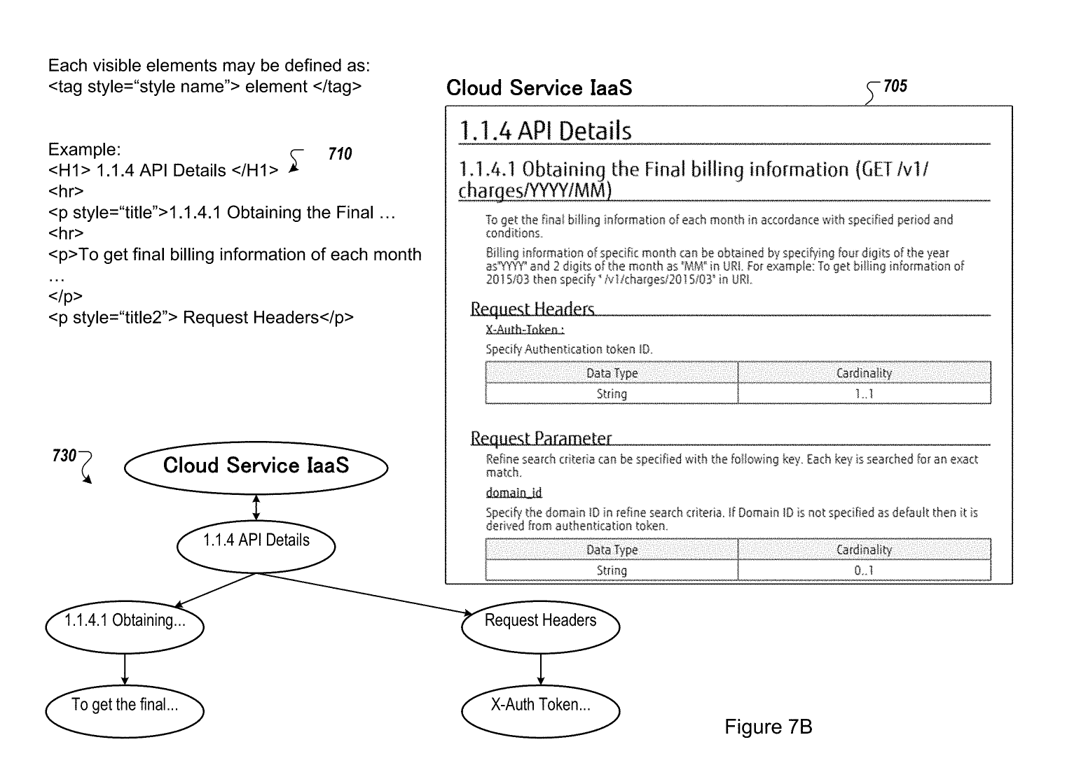

At block 225, the processing logic may develop a semantic view for each sentence in the API document. In at least one embodiment, the processing logic may develop the semantic view for each sentence based on the α parameter, the β parameter, and the γ parameter. An example semantic view is illustrated and further described with respect to FIG. 7. The processing logic may also update the semantic view process, such as in response to an addition of a new entity to the ontology or an extension of the initial ontology.

One skilled in the art will appreciate that, for this and other procedures and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the disclosed embodiments.

FIG. 3 illustrates a flow diagram of an example method 300 to generate a relationship model. An electronic document may include metadata. For example, a webpage may include HTML tags and CSS codes. These metadata allow a web browser to process and parse the code and generate a visible view of the content to users. In an example, HTML may detail how a webpage may look, the ordering of elements or nested elements on the webpage, and the orchestration of the webpage. CSS may provide color, fonts, and style, etc. of the content and each tag may use a CSS style.

The method 300 may begin at block 305, where the processing logic may select a group of electronic documents. The processing logic may select from a corpus that includes a large number of webpages with different subjects. The processing logic may read a group of webpages (e.g., domain pages) from the corpus. For example, the processing logic may read all pages of a website or all pages related to a subject. The processing logic may select each webpage from a set of domain pages.

At block 310, the processing logic may parse each electronic document to identify initial metadata. For example, the processing logic may parse HTML tags in each electronic document.

At block 315, the processing logic may extract the initial metadata from each electronic document. For example, the processing logic may extract HTML tags from each HTML-based electronic document.

At block 320, the processing logic may parse each electronic document to identify additional metadata. For example, the processing logic may parse electronic document based on the initial metadata. For example, the processing logic may parse a CSS style for each HTML tag extracted at block 315.

At block 325, the processing logic may generate an initial relationship model based on the metadata extracted at blocks 315 and 320. The initial relationship model may show a relation or hierarchy between elements in one electronic document using the metadata (e.g., the HTML tags and CSS style).

At block 330, the processing logic may generate a vector of elements that appear in the electronic document. In at least one embodiment, the processing logic may use a training set of data to generate the vector of elements. For instance, the relation between tags in HTML file or CSS style structure may be part of the training set of data. In at least one embodiment, the assigned vector of each element may be added to HTML as a HTML tag (which may not be readily visible to user).

At block 335, the processing logic may update the initial relationship model based on the vector of elements to generate an updated relationship model. In at least one embodiment, the initial relationship model may be adjusted based on the metadata (e.g., the HTML tags and/or the CSS styles) appearing in the electronic document. At block 340, the processing logic may add the updated relationship model to a vector corpus.

At block 345, the processing logic may generate a statistical model of the electronic document that may be added to the vector corpus. The statistical model may include a probability of appearing elements based on their metadata (e.g., HTML tags and CSS styles). For example, a <H1> tag is a header, and it has a higher priority of a paragraph tag in HTML (<p>). Therefore, a statistical model which may be used the <h1> and <p> rules, may to provide a higher rank for the following statement: <h1>→<p>; and a lower rank for <p>→<h1>. If in the training set of data, there is no record of detecting the level of tags from one side, then the statistical model may help to select the best choice with higher probability. The statistical model may help the processing logic to estimate appearances of elements based on HTML tags, CSS styles and the result of NLP on content. The statistical model can be generated based on target domain. For instance, it can be generated for API documentation. Therefore, the model can provide different probabilities based on different contents.

FIG. 4 illustrates a flow diagram of an example method 400 related to tagging an electronic document. The method 400 may begin at block 405, where the processing logic may extract all HTML tags and a hierarchy model of tags in the electronic document. The HTML tags and a hierarchy model of tags may provide a first view of relation between elements in the electronic document.

At block 410, the processing logic may extract one or more CSS styles for each HTLM tag. The extracted CSS styles may improve the first view of relation by adding CSS styles.

At block 415, the processing logic may use a relationship model (e.g., the relationship model or a vector model generated in FIG. 3) to compute a probability of relation of each HTML tag, its CSS style, as well as a final relation between elements. The results of this processing may improve the previous relation based on a probability rate of relation between elements.

At block 420, the processing logic may select HTML tags with the highest probability rates. At block 425, the processing logic may assign a vector relation between elements as an embedded file in the source webpage or as an individual file. The vector relation may be stored as a set of <key, value> which may be stored in a NoSQL database or embedded inside the HTML file for further processing.

FIG. 5 illustrates a flow diagram of an example method 500 of segmentation of an electronic document. The method 500 may begin at block 505, where the processing logic may identify an electronic document. The electronic document may include an electronic document discussed in FIGS. 1-4. The processing logic may extract a webpage from the web, from a local network or from a local disk.

At block 510, the processing logic may assign tags to elements of the electronic document, as further described in conjunction with FIG. 4. At block 515, the processing logic may extract relation between elements of the electronic document.

At block 520, the processing logic may identify a number of segments of the electronic document. In at least one embodiment, the processing logic may identify the number of segments of the electronic document based on a relationship model.

At block 525, the processing logic may identify a probability of assigning each element to each segment. The processing logic may select the highest probability rates for each segment.

At block 530, the processing logic may generate a segmentation of the electronic document based on highest probability rates for each segment.

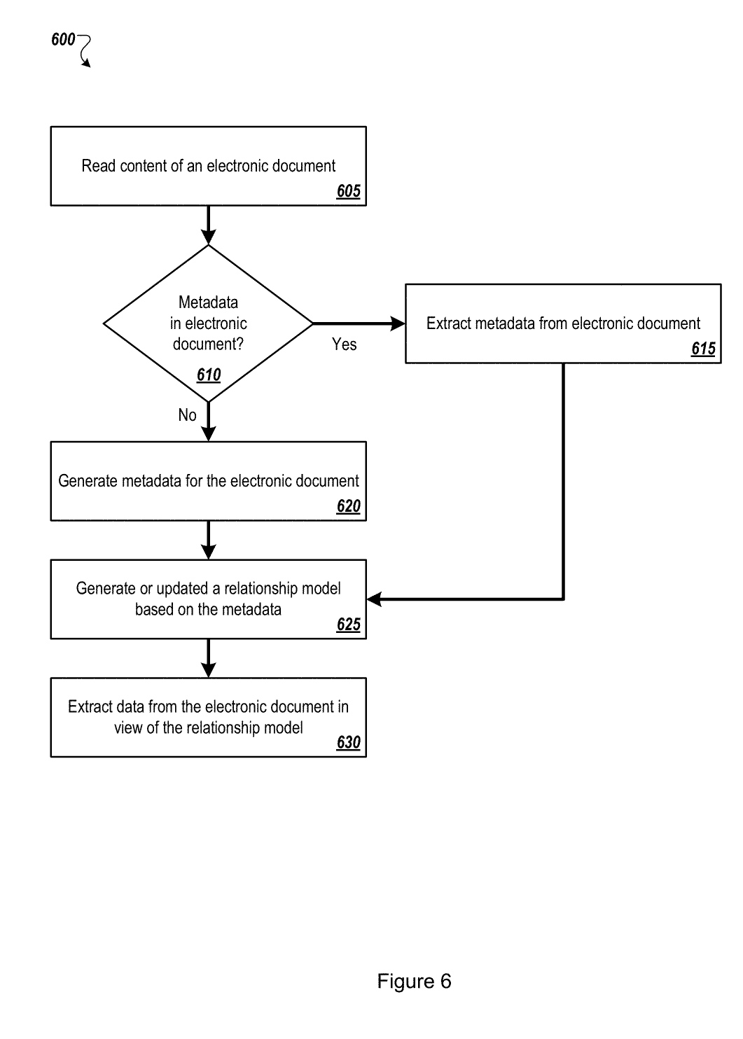

FIG. 6 illustrates a flow diagram of an example method 600 of natural language processing of any type of electronic document. For example, a reading process of the relation metadata between elements and segmentation may be added to a web browser or as a plug in for a web browser. The method 600, for example, is capable to read relation between elements from an embedded HTML file or from an individual file that shows a relation between elements and a segmentation view of the electronic document. The method 600 is capable to be applied to other document source files rather than a webpage, such as a PDF file, Word Document, RDF, ODF, XPS, XML, Power Point file, Excel File, PS file. For example, file may be retrieved from the Internet or transferred through disk, flash memory, hard disk, etc.

The method 600 may begin at block 605, where the processing logic may read the original electronic document (e.g., a PDF file, Word® document file, XPS file, Power Point® file, XML, RDF, Excel® File, PS file, etc.

At block 610, the processing logic may determine whether the electronic document includes metadata. When the processing logic determines that the electronic document includes metadata (“YES” at block 610), the processing logic may extract metadata from the electronic document at block 615. For example, Second, some source files may include XML-based metadata, such as Microsoft Word® documents and ODF file from OpenOffice. In these and other similar instances, the processing logic may use this metadata to understand the style of each paragraph, sentence and words. The processing logic may proceed to block 625.

When the processing logic determines that the electronic document does not include metadata (“NO” at block 610), the processing logic may generate metadata for the electronic document at block 620. The processing logic may generate metadata for the electronic document based on font style, font type, font format, color for each section, and other properties of the electronic document.

At block 625, the processing logic may generate a relationship model for the electronic document. In at least one embodiment, the processing logic may use the metadata extracted at block 615 or metadata generated at block 620 to generate an initial relationship model (FIG. 3), an updated relationship model based on the metadata, (FIG. 4) and segmentation of the electronic document (FIG. 5). At block 630, the processing logic may extract information from the electronic document in view of the relationship mode.

FIG. 7A illustrates an example electronic document 705 that may be processed to generate an initial relationship model 720. The electronic document may include one or more unstructured or semi-structured elements, such as human language text, images, title, table, audio, video, etc. The electronic document 705 may be processed by processing logic, as described above, such as by performing some of all of the method 200 or 300. The processing logic may generate a semantic view of the electronic document 705. The semantic view may provide a meaning or each element by considering the correlation between elements in the electronic document 705 and/or correlation between elements in multiple electronic documents (not illustrated in FIG. 7A).

The processing logic may use font size and format, for example, to detect a correlation between elements of the electronic document 705. In this example, processing “X-Auth-Token:”, “Specify Authentication token ID.” and the table below that text, may not provide a clear description of the content. However, when using a correlation between elements in the electronic document 705, the processing logic may have more information about the electronic document 705 and how to extract information with higher accuracy.

The processing logic may generate the initial relationship model 720 of the electronic document 705. In at least one embodiment, each visible elements may be define as: <tag style=“style name”> element </tag>. Example HTML code 710 may include:

<H1> 1.1.4 API Details </H1>
<hr>
<p style=“title”>1.1.4.1 Obtaining the Final ...
<hr>
<p>To get final billing information of each month ...
</p>
<p style=“title2”> Request Headers</p>

The processing logic may parse this HTML code and generate the initial relationship model 720 based on the parsed elements.

FIG. 7B illustrates an example electronic document 705 that may be processed to generate an updated relationship model 730. The processing logic may use HTML tags and/or CSS styles to adjust the initial relationship model 720 of FIG. 7A based on probability rates of the HTML tags and/or CSS styles. For example, the training set of data may indicate that a smaller font size is part of an element with a larger font size. Thus, the text “To get the final . . . ”, which has a smaller font size, may be part of the element “1.1.4.1 Obtaining . . . ” which may have a larger font size. The updated relationship model 730 may reflect this subordinate relationship between elements.

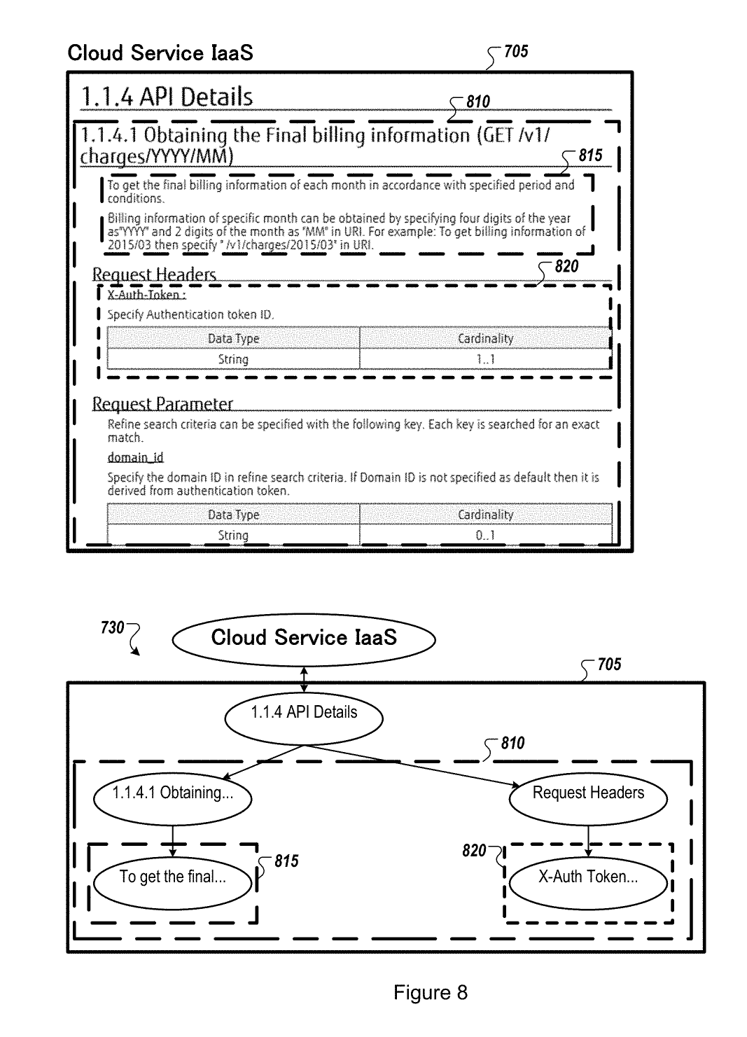

FIG. 8 illustrates example segmentation of the electronic document 705. The electronic document 705 may be segmented by the processing logic described above. For example, the processing logic may identify segments 810, 815, 820.

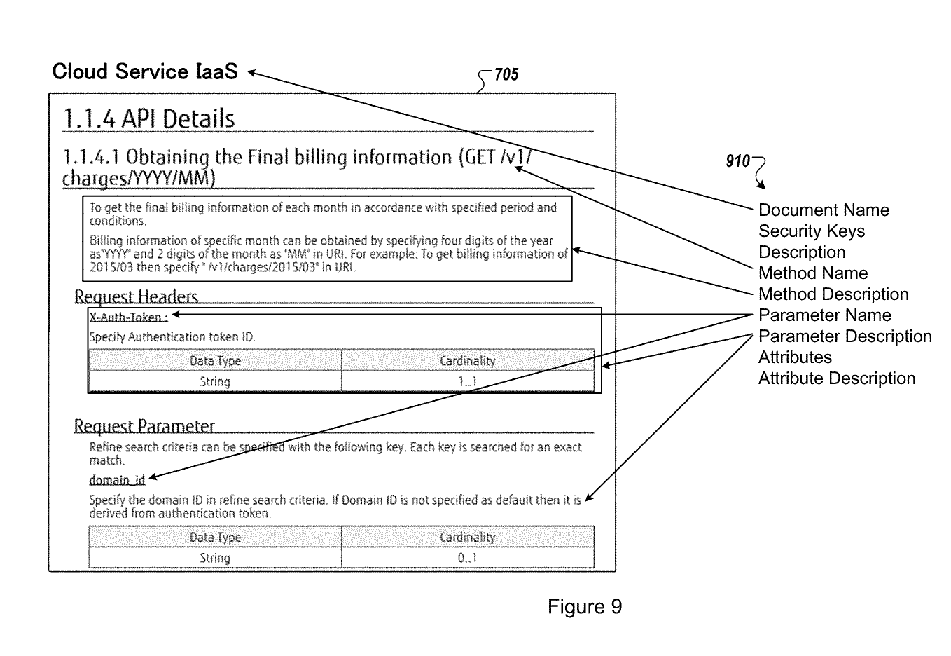

FIG. 9 illustrates an example text extraction using document segmentation information. In at least one embodiment, processing logic may apply a text extraction (e.g., a NLP method) to the electronic document 705, such as using the page segmentation information identified in FIG. 8. The processing logic may identify segmentation of each extracted data from the electronic document 705 and may extract information from the segments 810, 815, 820. For example, the processing logic may identify a document name, security keys, description, method name, method description, parameter name, parameter description, attributes, attribute description, etc. The processing logic may assign a segmentation number to the extracted data. Based on a hierarchy model of extraction, the processing logic may find relative information (e.g., find related extracted data).

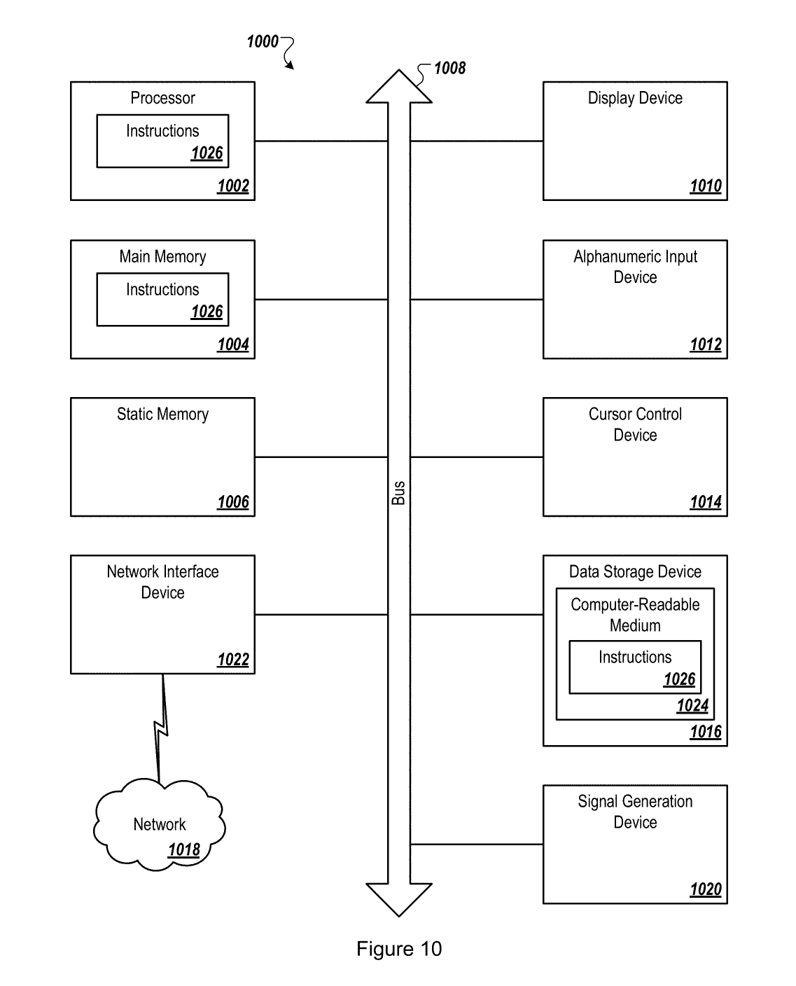

FIG. 10 illustrates a diagrammatic representation of a machine in the example form of a computing device 1000 within which a set of instructions, for causing the machine to perform any one or more of the methods discussed herein, may be executed. The computing device 1000 may include a mobile phone, a smart phone, a netbook computer, a rackmount server, a router computer, a server computer, a personal computer, a mainframe computer, a laptop computer, a tablet computer, a desktop computer etc., within which a set of instructions, for causing the machine to perform any one or more of the methods discussed herein, may be executed. In alternative embodiments, the machine may be connected (e.g., networked) to other machines in a LAN, an intranet, an extranet, or the Internet. The machine may operate in the capacity of a server machine in a client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The example computing device 1000 includes a processing device (e.g., a processor) 1002, a main memory 1004 (e.g., read-only memory (ROM), flash memory, dynamic random access memory (DRAM) such as synchronous DRAM (SDRAM)), a static memory 1006 (e.g., flash memory, static random access memory (SRAM)) and a data storage device 1016, which communicate with each other via a bus 1008.

Processing device 1002 represents one or more general-purpose processing devices such as a microprocessor, central processing unit, or the like. More particularly, the processing device 1002 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1002 may also include one or more special-purpose processing devices such as an application specific integrated circuit (ASIC), a field programmable gate array (FPGA), a digital signal processor (DSP), network processor, or the like. The processing device 1002 is configured to execute instructions 1026 for performing the operations and steps discussed herein.

The computing device 1000 may further include a network interface device 1022 which may communicate with a network 1018. The computing device 1000 also may include a display device 1010 (e.g., a liquid crystal display (LCD) or a cathode ray tube (CRT)), an alphanumeric input device 1012 (e.g., a keyboard), a cursor control device 1014 (e.g., a mouse) and a signal generation device 1020 (e.g., a speaker). In one implementation, the display device 1010, the alphanumeric input device 1012, and the cursor control device 1014 may be combined into a single component or device (e.g., an LCD touch screen).

The data storage device 1016 may include a computer-readable storage medium 1024 on which is stored one or more sets of instructions 1026 (e.g., computer device 110, document processing engine 126) embodying any one or more of the methods or functions described herein. The instructions 1026 may also reside, completely or at least partially, within the main memory 1004 and/or within the processing device 1002 during execution thereof by the computing device 1000, the main memory 1004 and the processing device 1002 also constituting computer-readable media. The instructions may further be transmitted or received over a network 1018 via the network interface device 1022.

While the computer-readable storage medium 1026 is shown in an example embodiment to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data, which cause a general purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present inventions have been described in detail, it should be understood that the various changes, substitutions, and alterations could be made hereto without departing from the spirit and scope of the invention.

What is claimed is:

1. A system, comprising:
a memory;
a communication interface; and
a processor operatively coupled to the memory and the communication interface, the processor being configured to perform operations comprising:
identifying an electronic document that includes one or more elements;
generating a relationship model between the elements of the electronic document by providing the probability of assigning elements based on a training set for a particular domain;
identifying metadata associated with the electronic document;
modifying the relationship model based on the metadata;
segmenting the electronic document into at least two segments based on the modified relationship model; and
extracting information from the electronic document based on the at least two segments.

2. The system of claim 1, wherein the metadata includes at least one of HyperText Markup Language (HTML) code, a Cascading Style Sheets (CSS) style, and a set of natural language words.

3. The system of claim 1, wherein the relationship model between the elements of the electronic document is generated based on a training set of data and the training set of data includes predefined relationships of HTML tags, CSS elements and a target natural language domain.

4. The system of claim 1, wherein the generating the relationship model between the elements of the electronic document comprises:
parsing the electronic document; and
generating the relationship model based on the parsed document.

5. The system of claim 4, wherein the identifying the metadata associated with the electronic document comprises parsing CSS styles of the electronic document and the modifying the relationship model based on the identified metadata comprises modifying the relationship model based on the parsed CSS styles.

6. The system of claim 5, wherein the processor is further configured to perform an operation comprising labeling the at least two segments based on the parsed electronic document, such as with HTML tags and CSS styles.

7. The system of claim 1, wherein the processor is further configured to perform an operation comprising tagging the electronic document with a set of tags that identify relationships between elements of the electronic document, wherein the electronic document is segmented into the at least two segments based on the set of tags.

8. The system of claim 7, wherein the processor is further configured to perform operations comprising:
generating a relation vector based on the set of tags; and
performing at least one of:
adding the relation vector to the electronic document, or
adding the relation vector as a set of HTML tags to the electronic document.

9. The system of claim 1, wherein the processor is further configured to perform an operation comprising organizing extracted data based on the segmentation to identify related extracted data.

10. A method, comprising:
identifying an electronic document that includes one or more elements;
generating a relationship model between the elements of the electronic document by providing the probability of assigning elements based on a training set for a particular domain;
identifying metadata associated with the electronic document;
identifying the relationship model based on the metadata;
segmenting the electronic document into at least two segments based on the modified relationship model; and
extracting information from the electronic document based on the at least two segments.

11. The method of claim 10, wherein the relationship model between the elements of the electronic document is generated based on a training set of data and the training set of data includes predefined relationships of elements.

12. The method of claim 10, wherein the generating the relationship model between the elements of the electronic document comprises:
parsing HyperText Markup Language (HTML) of the electronic document; and
generating the relationship model based on the parsed HTML.

13. The method of claim 12, wherein the identifying the metadata associated with the electronic document comprises parsing Cascading Style Sheets (CSS) styles of the electronic document and modifying the relationship model based on the identified metadata comprises modifying the relationship model based on the parsed CSS styles.

14. The method of claim 10 further comprising tagging the electronic document with a set of tags that identify relationships between elements of the electronic document, wherein the electronic document is segmented into the at least two segments based on the set of tags.

15. The method of claim 14 further comprising:
generating a relation vector based on the set of tags; and
performing at least one of:
adding the relation vector to the electronic document, or
adding the relation vector as a set of HTML tags to the electronic document.

16. The method of claim 10 further comprising organizing the extracted data based on the segmentation to identify related extracted data.

17. A non-transitory computer-readable medium having encoded therein programming code executable by a processor to perform operations comprising:
identifying an electronic document that includes one or more elements;
generating a relationship model between the elements of the electronic document;
identifying metadata associated with the electronic document;
modifying the relationship model based on the metadata;
segmenting the electronic document into at least two segments based on the modified relationship model; and
extracting information from the electronic document based on the at least two segments.

18. The non-transitory computer-readable medium of claim 17, wherein the generating the relationship model between the elements of the electronic document comprises:
parsing HyperText Markup Language (HTML) of the electronic document; and
generating the relationship model based on the parsed HTML.

19. The non-transitory computer-readable medium of claim 18, wherein the identifying the metadata associated with the electronic document comprises parsing Cascading Style Sheets (CSS) styles of the electronic document and the modifying the relationship model based on the identified metadata comprises modifying the relationship model based on the parsed CSS styles.

20. The non-transitory computer-readable medium of claim 17, wherein the operations further comprise organizing extracted data based on the segmentation to identify related extracted data.
